(19) United States
(12) Patent Application Publication
(10) Pub. No.: US 2002/0055847 A1
(43) Pub. Date: May 9, 2002

(54) METHOD AND APPARATUS OF PROVIDING SECURE TRANSACTIONS ON A NETWORK

(76) Inventors: MASAHIRO NAKANO, LOS ALTOS, CA (US); ROLF TOFT, PALO ALTO, CA (US); TOSHIYA FUJII, MENLO PARK, CA (US); KENT LAWRENCE HEADLEY, SAN JOSE, CA (US); ROBERT BRADLEY ROSIN, LOS ALTOS, CA (US)

Correspondence Address: J. William Wigert, Jr., Two Embarcadero Center, PO Box 79636, Suite 2000, San Francisco, CA, 94120-7936, US

(21) Appl. No.: 09/233,765

(22) Filed: Jan. 20, 1999

(51) Int. Cl. G06F 17/60

(52) U.S. Cl. 705/1; 705/56; 705/74

(57) ABSTRACT

A method of, and apparatus for, doing business transactions on a network, such as the Internet, is described. Purchases are carried out in a secure way such that there is a minimum possibility that the customer's financial or billing information can be stolen. An input device, such as a set top box, television browser, is provided at a customer's location. The input device has a unique identification code. This code is stored on a first server connected to a network, such as the Internet, prior to conducting any transactions. Customer specific financial and/or billing information is also stored on the first server. The customer is then connected to the desired location on the network through a second server to conduct a transaction. The identification code of the input device is also provided to the second server connected to the network. The second server has secure access to the customer specific information located on the first server, for billing the customer. Where the input device is a set top box browser, a smart card port may be provided. As a marketing device, the smart card can be provided by a vendor. The smart card is encoded with the URL location of the vendor's website. A user inserts the smart card into the input device, such as a television set top box browser, to automatically connect to the vendor's website. By using a smart card, information can be downloaded from the vendor's website to the customer's smart card.

### BACKGROUND OF THE INVENTION

1. Field of the Invention

The present invention relates to a method of, and apparatus for, allowing a customer to shop and purchase products or services on a wide area network, such as the Internet, in a way that insures that any transactions as well as customer financial and billing information is secure.

2. Related Art

Networks work by sending information from computer to computer (or server to server) until information reaches its destination. The Internet, and more specifically the World Wide Web (hereinafter referred to collectively as the “Internet”), is a vast world wide network, used for a variety of purposes including purchasing goods and services. More specifically, the Internet is a global communications network, comprised of a network of networks which are both public and private. The world wide web (www), is a subset of the Internet. The world wide web allows people to jump from one server to another simply by selecting a highlighted word, picture or icon about which they want more information. This is a maneuver which is called a “hyperlink”. To use the world wide web a user loads a special navigation program, called a web browser, onto his or her computer or other device which is connected to an Internet service provider, most typically by means of a telephone line. The Internet service provider is connected to one of the networks making up the Internet.

The typical connection of most users to the Internet is via a personal computer which is connected through a telephone link to an Internet service provider. More recently, however, a company known as WebTV Networks has developed an Internet service. WebTV Networks offers a service wherein the user can watch television and, also, from the same television set, access the Internet. DSS, or satellite-linked television, also provides an Internet link to users.

When data is sent from point A to point B, every computer in between has an opportunity to look at what's being sent. This can pose a security problem. For example, if a potential buyer using the Internet is viewing a catalog from a vendor and decides to make a purchase, the user has to provide information into an order form from his PC or set top box. The information, typically, includes the purchaser's mailing address and credit card number. This information then passes from computer to computer on the way to the vendor. It is possible that along the way criminals can intercept this information, including the credit card information, and use the information to the detriment of the purchaser.

To combat such illegal activity, a number of approaches have been taken to allow such purchase transactions to take place with greater security. “Secure” sites have been set up which provide measures to prevent unauthorized people from seeing the data sent to or from those sites. SSL (secure socket layer) is an encryption based security technology used on the Internet. But SSL has not been proven to be completely secure and some users have hesitated to use this approach to pay for goods bought over the Internet.

WebTV, a trademark of WebTV Networks, Inc., a subsidiary of Microsoft Corp., refers to a service and to a television browser which allows a consumer to have access to and browse the Internet, as well as communicate through electronic mail, by using a television instead of a personal computer or other input device. A number of consumer electronics industry leaders, including Sony Electronics Inc. are licensed to provide hardware for use with WebTV Networks television browsers. The hardware includes standalone set-top browser boxes as well as integrated devices. For example, Sony markets a model Int-W200 for television browsers and Internet access.

Television browsers appeal to a diverse consumer marketplace because television browsers offer Internet access to consumers which is affordable and easy to use. With the expanded use of television browsers the amount of purchases over the Internet will increase. This, in turn, will increase the need for means for insuring the security of purchase transactions.

### SUMMARY OF THE INVENTION

In accordance with the invention, a method, and apparatus for, doing business transactions on a network, such as the Internet, is described. More particularly, business transactions, such as purchases are carried out in a secure way such that there is a minimum possibility that customer financial or billing information can be stolen. In accordance with the invention an input device, such as a set top browser box is provided at a customer's location. The input device has an embedded unique identification code. The unique identification code for a customer's input device is stored on a first server connected to a network, such as the Internet, prior to conducting any transactions. Customer specific financial and/or billing information is also stored on the first server along with the unique identification code for the input device prior to any transactions taking place. The input device provides a location on the network to be connected when it is desired to conduct business transactions. In the case of the Internet, the location is the URL location of the desired web site. The customer is then connected to the desired location on the network to conduct a transaction such as a purchase.

The identification code of the input device is also provided to a second server connected to the network, such as the Internet. The first server has secure access to the customer specific information located on the second server. This is accomplished, for example, through encryption or by a secure line. The customer is free to conduct a transaction and the transaction is completed without revealing the customer credit card or billing information at the remote location. The customer is then billed, electronically or otherwise, after the transaction takes place at the remote location.

Where the input device is a set top box browser for cable or satellite television system, a smart card port is sometimes provided. A serial number associated with the smart card is also provided to the second server when a transaction is desired. The input device can be any device having access to the network, including a PC and should not be limited to the input devices described herein.

In accordance with another aspect of the invention, a smart or other card can be distributed by a vendor. The smart card is encoded with the URL location of the vendor's website. A user needs only insert the smart card into the input device, such as a television set top box browser, to automatically be connected to the vendor's website. By using a smart card, information can be downloaded from the vendor's website to the customer's smart card.

The foregoing and other objectives, features and advantages of the invention will be more readily understood upon consideration of the following detailed description of certain preferred embodiments of the invention, taken in conjunction with the accompanying drawings.

### BRIEF DESCRIPTION OF THE DRAWINGS

FIG. 1 is a block diagram of an information retrieval system according to the invention.

FIG. 2 is an illustration of a menu displayed on a television set of the system depicted in FIG. 1.

FIG. 3 is a block diagram illustrating the combination of a television set with a set top box browser usable with a smart card.

FIG. 4 is a diagram of a standard smart card.

FIG. 5 is a block diagram illustrating the method and apparatus of providing secure transactions over a network in accordance with the invention.

FIG. 6 illustrates a magazine which is provided with a tear out smart card for use by a consumer to purchase goods over the Internet.

FIG. 7 illustrates a set top box having two smart card ports.

### DETAILED DESCRIPTION OF THE PREFERRED EMBODIMENT

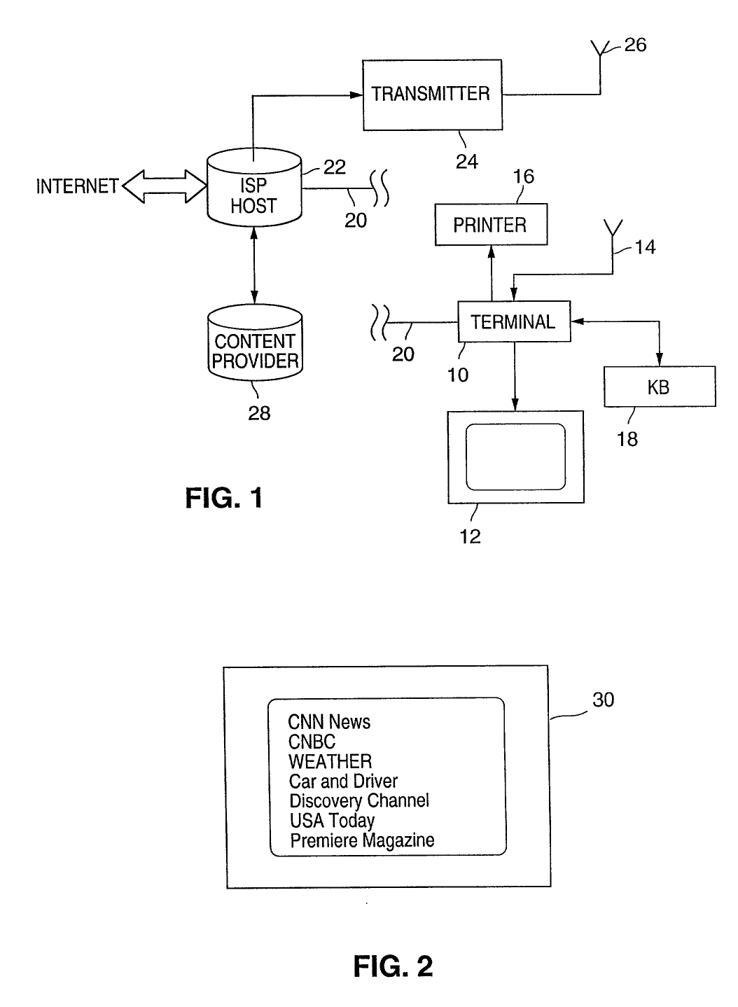

Referring now to FIG. 1, in one embodiment, a user input terminal 10 for a television browser connected to a user's television set 12. User input device 10 is commonly referred to as a “set top box”. The set top box 10 may be connected to a television antenna or cable television system 14 which provides a source of broadcast television signals to the set top box 10. Also connected to the terminal 10 is a user device 18, such as a keyboard, mouse, or remotely controlled cursor device. A printer 16 may also be connected to the set top box 10. The set top box 10 is connected through telephone lines 20 to an ISP host 22. The host 22 is part of a multiple user network. The host 22 sends information signals via a commercial broadcast transmitter 24 to be broadcast over an antenna 26, through a commercial cable system, or via satellite.

The information supplied by the host 22 to the transmitter 24 is high bandwidth data which is embedded in the conventional TV broadcast signal. At the set top box 10 is a video modem (not shown) which can receive the high bandwidth signal embedded in the conventional TV broadcast and which can strip out the embedded data without disturbing the conventional TV broadcast signal. The stripped out data is then passed on to the television receiver 12.

The input device 10 is actually a special purpose computer loaded with a form of a web browser which presents a display 30, FIG. 2, on the television set 12 allowing the user to send and receive E-mails, visit chat rooms and use net groups, find local sites and services, and search and find subjects on the Internet as well as download full screen, full motion video and sound files. The above-described existing system allows a user of the set top box 10 to browse the Internet or other information content provided directly to the ISP host 22 by a content provider 28 and, if desired, to printout that information on the printer 16.

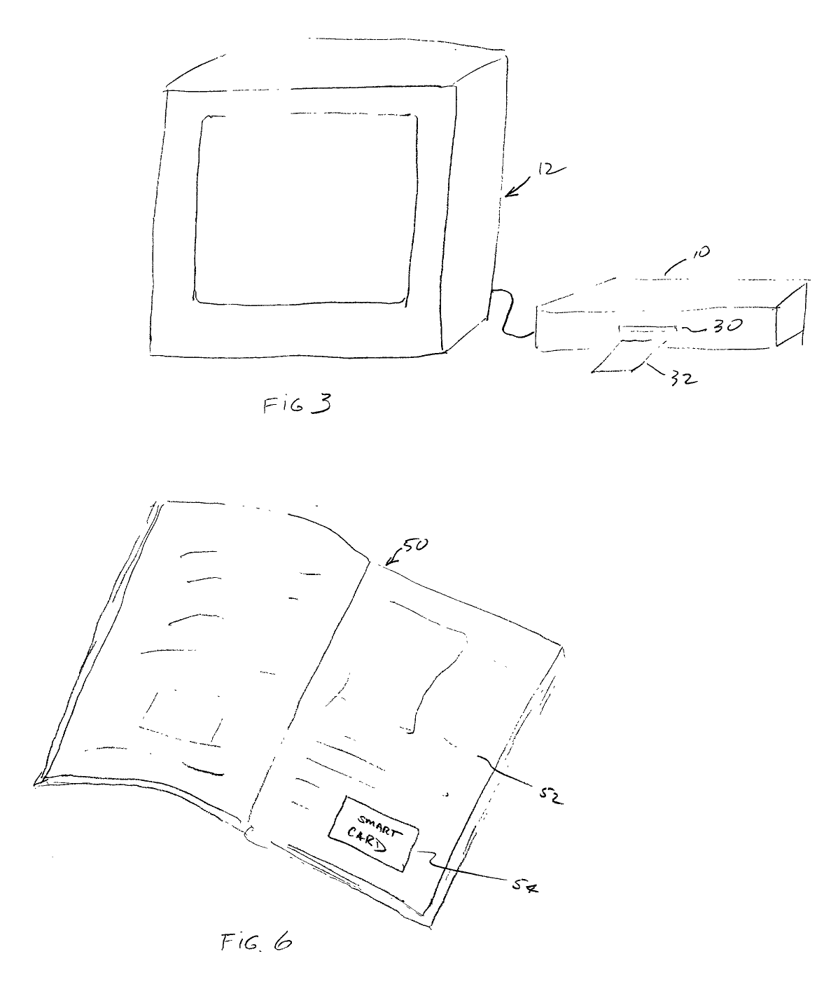

FIG. 3 shows the television 12 and set top box 10, with the set top box provided with a slot 30 which receives a conventional smart card 32. Smart cards allow customers the opportunity to purchase goods or services online. A smart card has integrated circuit chips embedded within a plastic card. The expression smart card was actually coined to describe a plastic card containing a microchip with processing capability. Today there are still more such cards containing just a memory chip which form the core of the telephone cards that have been so widely used in France and Germany. The more correct expression to cover all such cards is an integrated circuit card (ICC) as defined in the current ISO standards. The card 32, shown in FIG. 4, is 85.6 mm×53.98 mm×0.76 mm is the same size as the ubiquitous bank card with its magnetic stripe that is used as the payment instrument for numerous financial transactions. For purposes of this patent, the term “smart card” is used to include the “ICC” standard card. However, the present invention is not limited to such a standard smart card as described above. A non-standard smart card can be used. Also, where downloading of information is not required, a standard magnetic bank or credit type card can be used to provide, for example, URL information.

FIG. 5 is a block diagram illustrating the method and apparatus of providing secure transactions over a network in accordance with the invention. The secure system 40 includes one or more set top boxes 10 which are located at the customer's home, office or other desired location. Set top boxes 10 are provided with modems that connect thru telephone lines 20 to a network such as the Internet as explained above. For purposes of illustration, the Internet will be the only network discussed. It should be understood, however, that the present invention is not limited to the Internet but has application on any network or wide area network system. Further, while the invention described herein uses telephone lines to connect the consumer to the Internet, the invention should not be so limited. Other access modes such as cable, satellite and fiber optical cables could be used to carry out the present invention. For satellite connections the boxes are referred to as Integrated Receiver Decoders (IRDs).

Set top browser boxes 10, whether stand-alone or integrated into a host, use the architecture for the particular application, for example, the television browser architecture. Each set top unit, whether it be a stand-alone or integrated into a television set or other host, has a unique identification code (UID or SID) associated with it. This code is embedded within the set top unit and the user generally does not have access to it.

Connected to the Internet is a first data base (DB1) which is stored on a first computer or server 42 of an Internet service provider. This database contains the UID or SID for the customer's set top box. It also contains financial information for each customer necessary for on-line shopping. For example, billing information, credit information, and credit card numbers are stored in this data base. A high degree of security can be ensured for this stored information. Some Internet television companies, for example, have their own internal network which is available only to its users. Information about the customer may already be stored in this data base. In one embodiment, DB1, containing the customer billing and credit card information, is created before any transaction on the Internet takes place and is entirely independent of, and separated from, actual on-line shopping.

Like a conventional credit card, information can be stored and read from a smart card However, the amount of information which can be stored is significantly greater on a smart card. Also, unlike a conventional credit card, information can be down loaded and stored on the smart card. A smart card can have a serial number encrypted on it for additional security purposes.

To do a transaction, smart card 32 is inserted into port 30 of set top box 10. The serial number of smart card 32, along with the unique ID from the set top browser 10, is sent via the Internet 44 to a second database, DB2, located at server 46 at a second Internet service provider. Server 46 could, for example, be a server provided by the set top box manufacturer such as Sony Corp. or could be the Internet television server or any other provider's server. When a customer inserts smart card 32 for the first time, set top box 10 connects to the second database, DB2 and sends the unique ID and serial number of smart card 10. There the second database server, DB2, creates a new data combination of the unique ID and serial number of smart card 10 after verification of the same data combination stored previously. Only when server 46 has the unique ID of set top box 10 and the serial number of the user's smart card can server 46 gain access to the financial and billing information of the customer, located in DB1 at server 42, via a secure line, such as a dedicated line 48 or through an encrypted signal.

Service provider 46 then connects the user to the desired shopping location or service 50, based on the URL location. Should the customer desire to make a transaction such as a purchase, the customer simply indicates that the purchase is to be made, with no requirement of sending credit card information or any other financial information to the shopping service. The shopping server 50 sends the customer's shopping instructions along with the serial number of the smart card as the customer's identification to service provider 46. Then service provider 46 takes care of the transaction, relying upon the secure line 48 to DB1 for customer billing and financial information. The customer can then be charged or sent a monthly bill.

The use of a smart card 32 offers unique marketing advantages. For example, a shopping service can hand out or mail smart cards with the Internet URL for their website stored on the smart card. When the user inserts the smart card into the set top browser 10, the user is automatically linked with the website of the shopping service. This is accomplished as follows.

As explained above, the user's set top box 10 or similar input device contains a unique identification embedded within it, such as Silicon ID (SID). This SID is stored in DB1, the primary data base for each customer's billing information, credit card number, address and other financial information. The smart card 32, in the Internet application, contains the URL for the server 46 containing DB2 as well as the merchant's URL if DB2 is separate from the merchant's shopping server or e-commerce server (E-Shop). The smart card can contain its own unique identification or serial number, which is different from the SID of the input device.

When the customer inserts the smart card 32 into the set top box (input device) 10 the customer is connected to DB2. If the smart card provided by the merchant has no unique serial number, in one embodiment, DB2 issues it a unique serial number which is then stored on the smart card. At this point DB2 reads both the serial number for the smart card and the SID for the set top box. DB2, if desired, can prompt the customer for an input password for additional security. DB2 also stores the password. DB2 can also prompt a customer to provide additional information for personalized or customized shopping sites for the particular customer. Once DB2 is provided with the SID, smart card serial number, and password (if required), DB2 directs the customer to the desired shopping site's e-commerce server (E-SHOP).

After a transaction, such as a purchase, takes place at the desired shopping location, E-SHOP notifies DB2, identifying the purchaser's SID and serial number and that a transaction has taken place. At this point, DB2 sends a request to DB1 to complete the transaction at the customer's end. Since DB1 already has customer billing information associated with the customer's SID, the customer is charged in accordance with the pre-determined billing arrangement, and the customer can be notified by, for example, e-mail or regular mail that the transaction has been completed.

While the embodiment herein describes DB1, DB2, and the shopping service (E-SHOP) has three separate servers, in fact, any two or all three could be combined into a single server. DB1, or a cluster of servers comprising DB1 should have the capability of insuring that the customer can and will pay for the purchase. By providing customer specific information only on DB1 greater security is assured than with many present available security techniques. Additionally, DB2 can also have customer profile information useful to the shopping service. In this sense, DB2 can act as a “middleman” between the merchant and the customer, or selected customer bases.

With the smart card, information can be down loaded from the shopping service website. For example, if a customer makes a purchase, the shopping service may wish to put the customer in a “preferred” customer classification. This can be done easily by downloading a new URL site onto the customer's smart card so that the next time the customer inserts the smart card, the customer gets preferred treatment. Also, by having the ability to down load information onto the smart card, a particular group of customers can be targeted for special information.

FIG. 6 illustrates a magazine 50 having an advertisement 52 which has affixed to it a smart card 54 provided by the advertiser, for use by a consumer to purchase goods over the Internet. The smart card 54 is secured to the magazine page by, for example, an adhesive. The customer simply peels off the smart card and inserts it into the set top box, and automatically is connected with the vendor's website on the Internet.

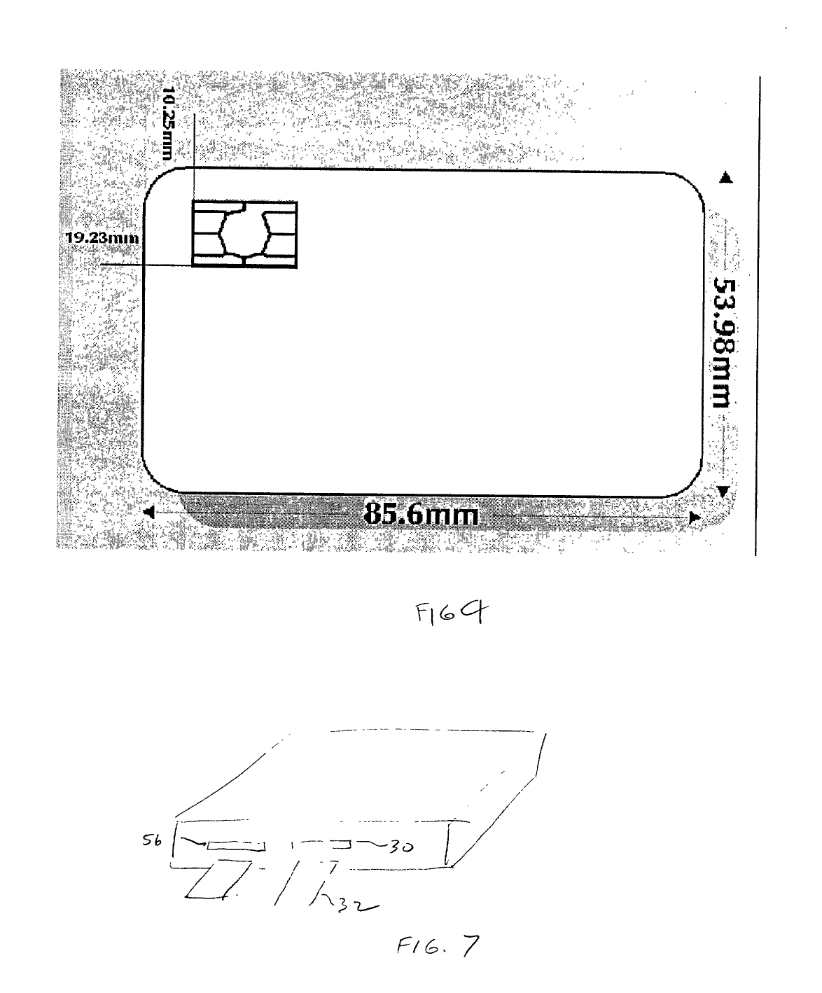

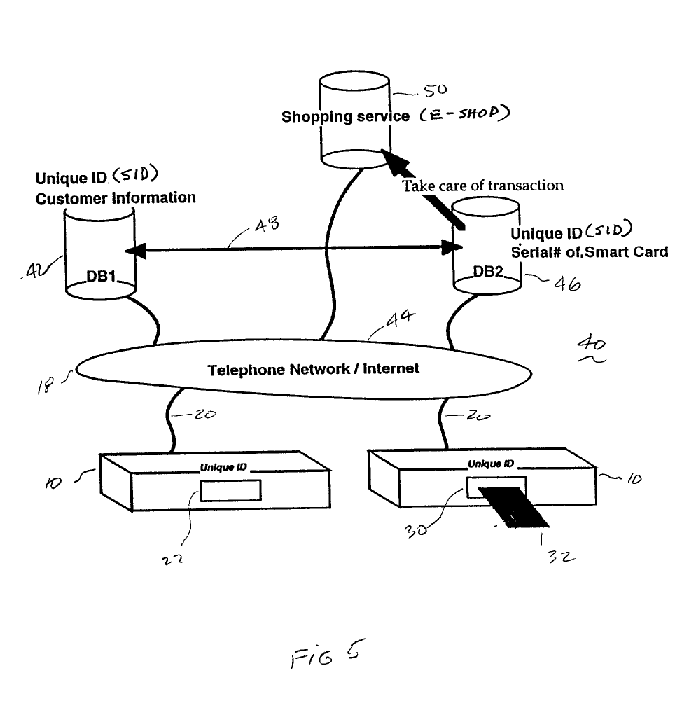

Since an advertiser-provider smart card would not have a customer serial number associated with it, a second smart card port can be provided, as shown in FIG. 7. With this arrangement the customer inserts his smart card 32 from which his smart card serial number is read and sent to DB2. The vendor-provided smart card 54 is inserted into the second smart card port 56, providing the vendor URL information.

Although the present invention has been shown and described with respect to preferred embodiments, various changes and modifications are deemed to lie within the spirit and scope of the invention as claimed. The corresponding structures, materials, acts, and equivalents of all means or step plus function elements in the claims which follow are intended to include any structure, material, or acts for performing the functions in combination with other claimed elements as specifically claimed.

As an example, the subject invention is not limited to television browsers or a set top box or for a particular form of data transmission. The subject invention is applicable to any system which has an input device with an imbedded, unique identification.

What is claimed is:

1. A method of conducting business transactions on a network comprising:
storing customer specific billing information on a first server connected to the network along with a unique identification code for a customer's input device prior to any transactions;
locating a desired location on the network to conduct a business transaction;
transmitting the identification code of the input device to a second server connected to the network;
providing the second server with secure access to the customer specific billing information on the first server; and
completing the business transaction at the desired location.

2. A method as in claim 1 wherein the step of locating a desired location on the network to conduct business transactions comprises inserting a card into the input device with the location of the desired location on the network.

3. A method as in claim 2 wherein the step of inserting a card into the input device includes the step of inserting a card with a unique serial number associated with the card.

4. A method as in claim 2 wherein the step of inserting a card into the input device includes the step of downloading a unique serial number onto the card.

5. A method as in claim 2 wherein the step of locating a desired location on the network to conduct a business transaction comprises inserting a smart card into the input device.

6. A method as in claim 2 including the step of locating a desired location on the network to conduct a business transaction comprises inserting a smart card into the input device with the location of a desired location on the network.

7. A method as in claim 1 including the step of providing potential customers with smart cards with a location of a site on the network stored on the smart card.

8. A method as in claim 1 wherein the step of transmitting the identification code of the input device to a second server connected to the network also includes the step of transferring a password to the second server.

9. A method as in claim 1 including the step of providing the first server, the second server and the desired location on the network in the same location.

10. A method as in claim 1 wherein the network comprises the Internet.

11. A method of conducting a secured purchasing transaction on the Internet comprising:
providing a unique identification code in a set top box browser for use with a television receiver at a customer's location;
storing the unique identification code on a first server connected to the Internet along with customer billing and/or financial information prior to conducting any purchase transactions;
connecting the customer to a selected location on the Internet to conduct a purchase transaction;
transmitting the identification code of the set top box browser to a second server connected to the Internet;
providing the second server with access to the customer billing and or/financial information in a secured manner;
conducting a purchase transaction at the desired location on the Internet; and
billing the customer independently of the transaction at the selected location.

12. A method as in claim 11 wherein the step of connecting the customer to a selected Internet location comprises inserting a smart card into the set top box with the location of the selected location on the Internet.

13. A method as in claim 12 including the additional step of providing a serial number associated with the smart card to the second server.

14. A method as in claim 12 including the additional step of downloading information from the selected location on the Internet to the smart card.

15. A method as in claim 11 wherein the step of connecting the customer to a selected Internet location comprises inserting a smart card, provided by a vendor which includes the vendor's location on the Internet, into the set top box.

16. An apparatus for performing secure business transactions on a network comprising:
a customer input device having a unique identification code;
means for storing customer specific billing information on a first server connected to the network along with the unique identification code prior to any transactions;
means for locating a desired site on the network to conduct a business transaction;
means for transmitting the identification code to a second server connected to the network;
means for providing the second server with secure access to the customer specific information on the first server;
means for conducting a transaction at a desired location; and
means for billing the customer independently of the transaction.

17. The apparatus of claim 16 wherein the means for locating a desired site on the network comprises a card which is inserted into the input device with the location of the desired site on the network.

18. The apparatus of claim 17 wherein the card is a smart card.

19. The apparatus of claim 16 including means for providing a serial number associated with the smart card to the second server.

20. The apparatus of claim 16 wherein the first server, the second server and the desired site are all located together.

21. The apparatus of claim 16 wherein the input device is a set top box browser for a television.

22. A method of conducting a secured transaction on the Internet comprising the steps of:
embedding a unique identification in a customer input device;
performing a transaction at a shopping server through a second server having access to the unique identification of the input device;
storing customer billing information on the first server;
communicating between the second server and a first server over a secured line that a transaction has taken place.

23. The method of claim 22 including the additional step of billing the customer based upon the billing information in the first server.

24. The method of claim 22 including the additional step of locating the first and second servers together.

25. The method of claim 22 including the additional step of combining the functions of the second server and the shopping server into a single server.

26. A method of allowing a customer to easily gain access to a site on the Internet comprising:
distributing a card containing the URL location of a website; and
inserting the card within a customer's internet access device.

27. The method of claim 26 wherein the step of distributing a card includes the step of distributing a smart card.

28. The method of claim 26 wherein the step of inserting the card includes the step of providing the card with a unique identification code.
